(19) United States
(12) Patent Application Publication
(10) Pub. No.: US 2026/0292241 A1
(43) Pub. Date: Sep. 24, 2026

(54) Methods and Apparatus of Syntax Design for Intra Prediction Fusion with Inherited Cross-Component Models

(71) Applicant: MEDIATEK INC., Hsin-Chu (TW)

(72) Inventors: Chia-Ming Tsai, Hsinchu City (TW); Chih-Wei Hsu, Hsinchu City (TW); Hsin-Yi Tseng, Hsinchu City (TW); Cheng-Yen Chuang, Hsinchu City (TW); Yi-Wen Chen, San Jose, CA (US); Ching-Yeh Chen, Hsinchu City (TW); Tzu-Der Chuang, Hsinchu City (TW)

(73) Assignee: MEDIATEK INC., Hsin-Chu (TW)

(21) Appl. No.: 19/471,700

(22) PCT Filed: Aug. 2, 2024
(86) PCT No.: PCT/CN2024/109496

§ 371 Date: Oct. 2, 2025

Related U.S. Application Data
(60) Provisional application No. 63/530,543, filed on Aug. 3, 2023.

(51) Int. Cl. H04N 19/593; H04N 19/186; H04N 19/70

(52) U.S. Cl. CPC H04N 19/593; H04N 19/186; H04N 19/70

(57) ABSTRACT

A method of video processing for encoding pictures includes receiving input data associated with a current block in a current video picture, determining whether a final prediction of the current block is a combination of cross-component prediction models or a fusion of a selected cross-component model with prediction by a non-cross-component coding tool, selecting the combination of cross-component prediction models or the fusion of the selected cross-component model with the prediction by non-cross-component coding tool as a current chroma prediction mode if the final prediction of the current block is the combination of cross-component prediction models or the fusion of the selected cross-component model with the prediction by the non-cross-component coding tool, generating the final prediction of the current block according to the current chroma prediction mode, and encoding the current block according to the final prediction of the current block.

### CROSS REFERENCE TO RELATED APPLICATION

This application claims the benefit of U.S. Provisional Application No. 63/530,543, filed on Aug. 3, 2023. The content of the application is incorporated herein by reference.

### BACKGROUND OF THE INVENTION

### 1. Field of the Invention

The present disclosure relates to video coding, and more particularly to chroma intra prediction techniques for video coding.

### 2. Description of the Prior Art

In the field of video coding, chroma intra prediction plays a crucial role in reducing the amount of data required to represent a video sequence while maintaining visual quality. Current chroma intra prediction techniques in modern video coding standards, such as H.265/HEVC (High Efficiency Video Coding) and VVC (Versatile Video Coding), employ a range of methods to predict chroma samples within a video frame. These techniques can be broadly categorized into two groups: those that exploit spatial correlations within the chroma components and those that leverage inter-component correlations between luma and chroma.

Traditional chroma intra prediction modes, such as Planar (mode 3), Vertical (mode 2), Horizontal (mode 1), DC (mode 0), and Derived Mode, primarily rely on spatial correlations within the chroma components. These modes predict chroma samples using neighboring reconstructed chroma samples or a combination of boundary samples. Additionally, angular modes, similar to luma intra prediction, predict chroma samples using directional correlations. In VVC, angular modes are extended to include Wide-Angle Intra Prediction (WAIP), which provides more granular directional predictions.

To exploit component correlations, several linear model-based techniques have been introduced. Cross-Component Linear Model (CCLM) predicts chroma samples using a linear model derived from neighboring reconstructed luma samples. Multi-model Linear Model (MMLM) extends this concept by using two linear models based on a threshold applied to inner luma sample values, allowing for a more adaptive prediction. Gradient Linear Model (GLM) incorporates directional information from luma samples by utilizing luma sample gradients instead of down-sampled luma values. Convolutional Cross-Component Model (CCCM) applies a convolutional model with a 7-tap filter to predict chroma samples from reconstructed luma samples. Furthermore, Position-Dependent Prediction Combination (PDPC) in VVC combines predicted chroma samples from multiple intra prediction modes based on the position of the samples within the block, resulting in a more localized and adaptive prediction.

These chroma intra prediction techniques have significantly improved the compression and decompression performance of modern video coding standards. However, there is still room for further optimization. One key problem is the lack of unified signalling for combining multiple chroma prediction modes. With the increasing number of chroma intra prediction techniques, there is a pressing need for a unified and efficient signalling approach that can effectively combine these techniques while minimizing overhead. Current video coding standards typically use separate signalling mechanisms for different prediction modes, which can lead to inefficiencies when multiple modes are combined. This limitation becomes more evident as new prediction techniques are introduced, potentially leading to increased signalling overhead and reduced coding efficiency.

### SUMMARY OF THE INVENTION

An embodiment discloses a method of video processing in a video coding system for encoding pictures. The method comprises receiving input data associated with a current block in a current video picture, determining whether a final prediction of the current block is a combination of a plurality of cross-component prediction models or a fusion of a selected cross-component model with prediction by a non-cross-component coding tool, selecting the combination of the plurality of cross-component prediction models or the fusion of the selected cross-component model with the prediction by the non-cross-component coding tool as a current chroma prediction mode if the final prediction of the current block is the combination of the plurality of cross-component prediction models or the fusion of the selected cross-component model with the prediction by the non-cross-component coding tool, generating the final prediction of the current block according to the current chroma prediction mode, and encoding the current block according to the final prediction of the current block.

An embodiment discloses a method of video processing in a video coding system for decoding pictures. The method comprises receiving a bitstream associated with a current block in a current video picture, determining whether a final prediction of the current block is a combination of a plurality of cross-component prediction models or a fusion of a selected cross-component model with prediction by a non-cross-component coding tool, selecting the combination of the plurality of cross-component prediction models or the fusion of the selected cross-component model with the prediction by the non-cross-component coding tool as a current chroma prediction mode if the final prediction of the current block is the combination of the plurality of cross-component prediction models or the fusion of the selected cross-component model with the prediction by the non-cross-component coding tool, generating the final prediction of the current block according to the current chroma prediction mode, and decoding the current block according to the final prediction of the current block.

An embodiment discloses an apparatus comprising a decoder circuit. The decoder circuit is used to receive a bitstream associated with a current block in a current video picture, determine whether a final prediction of the current block is a combination of a plurality of cross-component prediction models or a fusion of a selected cross-component model with prediction by a non-cross-component coding tool, select the combination of the plurality of cross-component prediction models or the fusion of the selected cross-component models with the prediction by the non-cross-component coding tool as a current chroma prediction mode if the final prediction of the current block is the combination of the plurality of cross-component prediction models or the fusion of the selected cross-component models with the prediction by the non-cross-component coding tool, generate the final prediction of the current block according to the current chroma prediction mode, and decode the current block according to the final prediction of the current block.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an example of 67 intra prediction modes in accordance with the embodiments.

FIG. 2 illustrates an example of the location of the left and above samples and the sample of the current block involved in the LM_LA mode in accordance with the embodiments.

FIG. 3 illustrates an example of classifying the neighbouring samples into two groups in accordance with the embodiments.

FIG. 4 illustrates an example of spatial part of the convolutional filter in accordance with the embodiments.

FIG. 5 illustrates an example of the reference area used to derive the filter coefficients in accordance with the embodiments.

FIG. 6 illustrates an example of gradient patterns for Gradient Linear Model in accordance with the embodiments.

FIG. 7 is a flowchart illustrating an embodiment of a video processing method for encoding a current block.

FIG. 8 is a flowchart illustrating an embodiment of a video processing method for decoding a current block.

FIG. 9 illustrates a simplified block diagram of a video encoder for video processing in accordance with the embodiments.

FIG. 10 illustrates a simplified block diagram of a video decoder for video processing in accordance with the embodiments.

### DETAILED DESCRIPTION

This disclosure delves into specific details to provide a comprehensive understanding, but those skilled in the art may practice it without these specifics. Well-known methods, procedures, components, and circuits are not described in detail to maintain clarity. The disclosure primarily focuses on video coding, but it can be applied to other fields as well.

For terms and techniques not specifically defined or described, reference may be made to video coding standards (e.g., MPEG standards) issued before this specification.

The following list contains acronyms used in this disclosure:
CU: Coding unit
CTB (LCU): Coding tree block (largest coding unit)
HEVC: High Efficiency Video Coding
VVC: Versatile Video Coding
MC: Motion compensation
MV: Motion vector
DF: Deblocking filter
T/IT: Transform/Inverse transform
Q/IQ: Quantization/Inverse quantization
SAO: Sample adaptive offset
ALF: Adaptive loop filter
QTBT: Quad-tree plus binary tree
QT: Quad-tree
BT: Binary-tree
TT: Ternary-tree
SPS: Sequence parameter set
PPS: Picture parameter set
APS: Adaptation parameter set
PH Picture header
SH: Slice header
   Intra Mode Coding with 67 Intra Prediction Modes

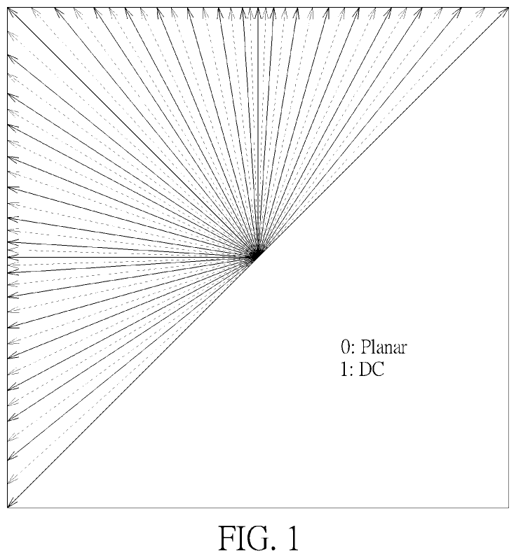

To capture the arbitrary edge directions presented in natural video, the number of directional intra modes in VVC is extended from 33, as used in HEVC, to 65. The new directional modes not in HEVC are depicted as red dotted arrows in FIG. 1, and the planar and DC modes remain the same. These denser directional intra prediction modes apply for all block sizes and for both luma and chroma intra predictions.

In VVC, several conventional angular intra prediction modes are adaptively replaced with wide-angle intra prediction modes for the non-square blocks. In HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid 15 division operations for DC prediction, only the longer side is used to compute the average for non-square blocks.

### Cross-Component Linear Model Prediction

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β \qquad ( 1 )$$

Where pred_{c}(i, j) represents the predicted chroma samples in a CU and rec_{L}(i, j) represents the downsampled reconstructed luma samples of the same CU.

The CCLM parameters (a and B) are derived with at most four neighbouring chroma samples and their corresponding down-sampled luma samples. Suppose the current chroma block dimensions are W×H, then W′ and H′ are set as
W′=W and H′=H when LM_LA mode is applied;
W′=W+H when LM_A mode is applied;
H′=H+W when LM_L mode is applied;

The above neighbouring positions are denoted as S[0, −1] . . . . S[W′−1, −1] and the left neighbouring positions are denoted as S[−1, 0] . . . . S[−1, H′−1]. Then the four samples are selected as:
S[W′/4, −1], S[3*W′/4, −1], S[−1, H′/4], S[−1, 3*H′/4] when LM_LA mode is applied and both above and left neighbouring samples are available;
S[W′/8, −1], S[3*W′/8, −1], S[5*W′/8, −1], S[7*W′/8, −1] when LM_A mode is applied or only the above neighbouring samples are available;
S[−1, H′/8], S[−1, 3*H′/8], S[−1, 5*H′/8], S[−1, 7*H′/8] when LM_L mode is applied or only the left neighbouring samples are available;

The four neighbouring luma samples at the selected positions are down-sampled and compared four times to find two larger values: x⁰_{A} and x¹_{A}, and two smaller values: x⁰_{B} and x¹_{B}. Their corresponding chroma sample values are denoted as y⁰_{A}, y¹_{A}, y⁰_{B} and y¹_{B}. Then x_{A}, x_{B}, y_{A} and y_{B} are derived as:

$${X}_{a} = ( {x}_{A}^{0} + {x}_{A}^{1} + 1 ) >> 1 \qquad ( 2 )$$

$${X}_{b} = ( {x}_{B}^{0} + {x}_{B}^{1} + 1 ) >> 1$$

$${Y}_{a} = ( {y}_{A}^{0} + {y}_{A}^{1} + 1 ) >> 1$$

$${Y}_{b} = ( {y}_{B}^{0} + {y}_{B}^{1} + 1 ) >> 1$$

Finally, the linear model parameters a and B are obtained according to the following equations:

$$α = \frac{{Y}_{a} - {Y}_{b}}{{x}_{a} - {x}_{b}} \qquad ( 3 )$$

$$β = {Y}_{b} - α \cdot {X}_{b} \qquad ( 4 )$$

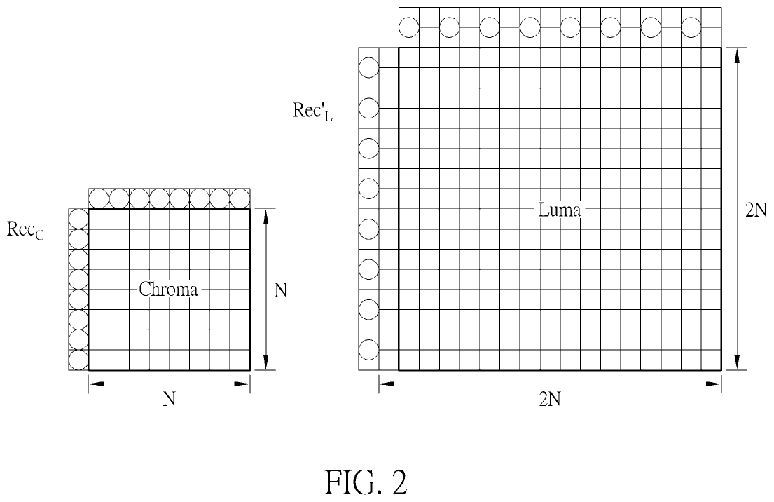

FIG. 2 shows an example of the location of the left and above samples and the sample of the current block involved in the LM_LA mode. The division operation to calculate parameter α is implemented with a look-up table. To reduce the memory required for storing the table, the diff value (difference between maximum and minimum values) and the parameter α are expressed by an exponential notation. For example, diff is approximated with a 4-bit significant part and an exponent. Consequently, the table for 1/diff is reduced into 16 elements for 16 values of the significant as follows:

$$DivTable [ ] = \{ 0 , 7 , 6 , 5 , 5 , 4 , 4 , 3 , 3 , 2 , 2 , 1 , 1 , 1 , 1 , 0 \} \qquad ( 5 )$$

This would have a benefit of both reducing the complexity of the calculation as well as the memory size required for storing the needed tables. Besides the above template and left template can be used to calculate the linear model coefficients together, they also can be used alternatively in the other 2 LM modes, called LM_A, and LM_L modes. In LM_A mode, only the above templates are used to calculate the linear model coefficients. To get more samples, the above templates are extended to (W+H) samples. In LM_L mode, only left template are used to calculate the linear model coefficients. To get more samples, the left templates are extended to (H+W) samples. In LM_LA mode, left and above templates are used to calculate the linear model coefficients. To match the chroma sample locations for 4:2:0 video sequences, two types of downsampling filter are applied to luma samples to achieve 2 to 1 downsampling ratio in both horizontal and vertical directions. The selection of downsampling filter is specified by a SPS level flag. The two downsmapling filters are as follows, which are corresponding to “type-0” and “type-2” content, respectively.

$$( 6 )$$

$${Rec}_{L}^{′} ( i , j ) = [ \begin{matrix}{rec}_{L} ( 2 i - 1 , 2 j - 1 ) + 2 \cdot {rec}_{L} ( 2 i - 1 , 2 j - 1 ) + {rec}_{L} ( 2 i + 1 , 2 j - 1 ) + \\ {rec}_{L} ( 2 i - 1 , 2 j ) + 2 \cdot {rec}_{L} ( 2 i , 2 j ) + {rec}_{L} ( 2 i + 1 , 2 j ) + 4\end{matrix} ] >> 3$$

$${rec}_{L}^{′} ( i , j ) = [ \begin{matrix}{rec}_{L} ( 2 i , 2 j - 1 ) + {rec}_{L} ( 2 i - 1 , 2 j ) + 4 \cdot {rec}_{L} ( 2 i , 2 j ) + \\ {rec}_{L} ( 2 i + 1 , 2 j ) + {rec}_{L} ( 2 i , 2 j + 1 ) + 4\end{matrix} ] >> 3 \qquad ( 7 )$$

Note that only one luma line (general line buffer in intra prediction) is used to make the downsampled luma samples when the upper reference line is at the CTU boundary. This parameter computation is performed as part of the decoding process, and is not just as an encoder search operation. As a result, no syntax is used to convey the a and B values to the decoder.

### Multiple Model CCLM

In the Joint Exploration Model (JEM), multiple model CCLM mode (MMLM) is proposed for using two models for predicting the chroma samples from the luma samples for the whole CU. In MMLM, neighbouring luma samples and neighbouring chroma samples of the current block are classified into two groups, each group is used as a training set to derive a linear model (i.e., a particular a and B are derived for a particular group). Furthermore, the samples of the current luma block are also classified based on the same rule for the classification of neighbouring luma samples.

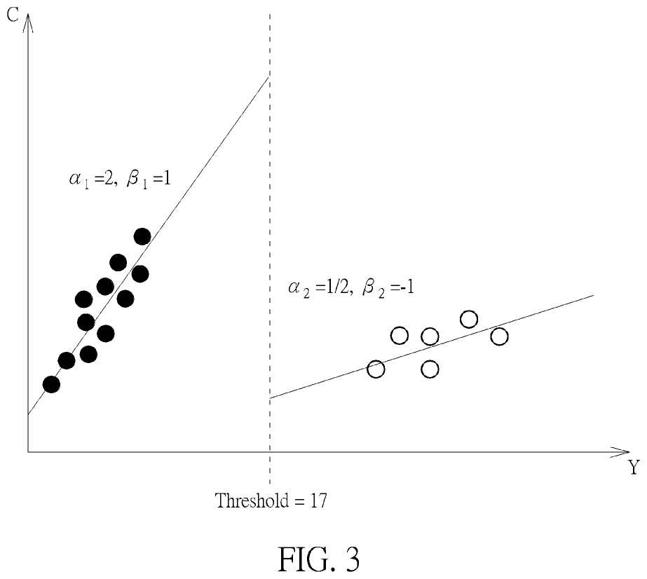

FIG. 3 shows an example of classifying the neighbouring samples into two groups. Threshold is calculated as the average value of the neighbouring reconstructed luma samples. A neighbouring sample with Rec′_{L}[x, y]<=Threshold is classified into group 1, while a neighbouring sample with Rec′_{L}[x, y]>Threshold is classified into group 2.

$$\{ \begin{matrix}P r e {d}_{C} [ x , y ] = {α}_{1} \times {Rec}_{L}^{′} [ x , y ] + {β}_{1} & if {Rec}_{L}^{′} [ x , y ] \leq Threshold \\ P r e {d}_{C} [ x , y ] = {α}_{2} \times {Rec}_{L}^{′} [ x , y ] + {β}_{2} & if {Rec}_{L}^{′} [ x , y ] > Threshold\end{matrix} \qquad ( 8 )$$

### Convolutional Cross-Component Model (CCCM)

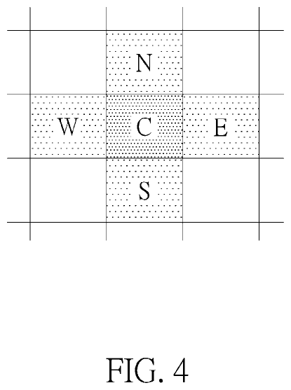

In Convolutional Cross-Component Model (CCCM), a convolutional model is applied to improve the chroma prediction performance. The convolutional model has 7-tap filter consist of a 5-tap plus sign shape spatial component, a nonlinear term and a bias term. The input to the spatial 5-tap component of the filter consists of a center (C) luma sample which is collocated with the chroma sample to be predicted and its above/north (N), below/south(S), left/west (W) and right/east (E) neighbors as illustrated in FIG. 4.

The nonlinear term (denoted as P) is represented as power of two of the center luma sample C and scaled to the sample value range of the content:

$$P = ( C * C + midVal ) >> bitDepth$$

That is, for 10-bit content it is calculated as:

$$P = ( C * C + 512 ) >> 10$$

The bias term (denoted as B or β) represents a scalar offset between the input and output (similarly to the offset term in CCLM) and is set to middle chroma value (512 for 10-bit content).

Output of the filter is calculated as a convolution between the filter coefficients ci and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B$$

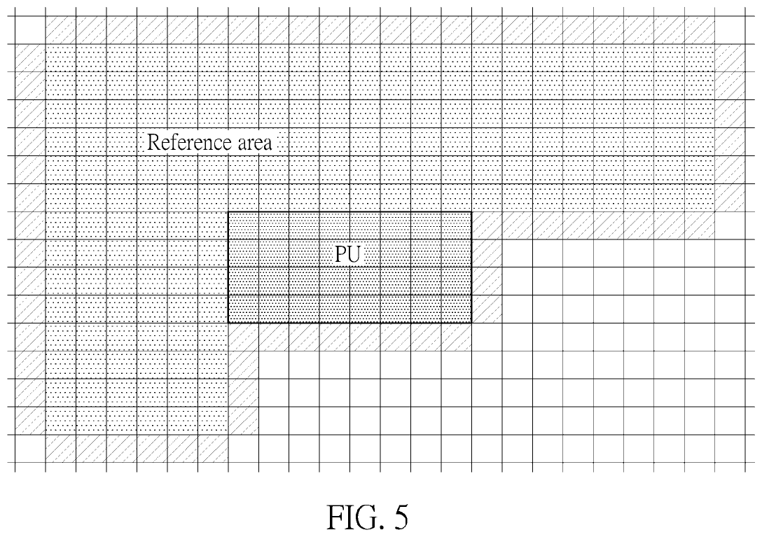

The filter coefficients ci are calculated by minimising MSE between predicted and reconstructed chroma samples in the reference area. FIG. 5 illustrates the reference area which consists of 6 lines of chroma samples above and left of the PU. Reference area extends one PU width to the right and one PU height below the PU boundaries. Area is adjusted to include only available samples. The extensions to the area shown in blue are needed to support the “side samples” of the plus shaped spatial filter and are padded when in unavailable areas.

The mean squared error (MSE) minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the adaptive loop filter (ALF) coefficients in Enhanced Compression Model (ECM), however LDL decomposition was chosen instead of Cholesky decomposition to avoid using square root operations.

### Gradient Linear Model (GLM)

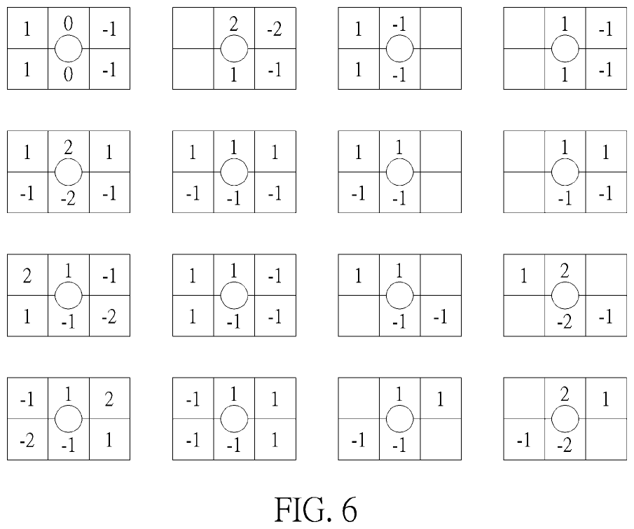

FIG. 6 illustrates gradient patterns for Gradient Linear Model (GLM). Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

For signalling, when the CCLM mode is enabled to the current CU, two flags are signalled separately for Cb and Cr components to indicate whether GLM is enabled to each component; if the GLM is enabled for one component, one syntax element is further signalled to select one of 16 gradient filters for the gradient calculation. The GLM can be combined with the existing CCLM by signalling one extra flag in bitstream. When such combination is applied, the filter coefficients that are used to derive the input luma samples of the linear model is calculated as the combination of the selected gradient filter of the GLM and the down-sampling filter of the CCLM.

The various methods described in the following paragraphs are to improve the cross-component prediction accuracy or coding performance.

### Signalling the Inherit Candidate Index in the List

An on/off flag is signalled to indicate if the current block inherits the cross-component model parameters from neighboring blocks or not. The flag can be signalled per CU/CB, per PU, per TU/TB, or per colour component, or per chroma colour component. A high level syntax could be signalled in SPS, PPS, PH or SH to indicate if the proposed method is allowed for the current sequence, picture, or slice.

If the current block inherits the cross-component model parameters from neighboring blocks, the inherit candidate index is signalled. The index could be signalled (e.g., signalled using truncate unary code, Exp-Golomb code, or fix length code) and shared among both the current Cb and Cr blocks. For another example, the index could be signalled per color component. For example, one inherited index is signalled for Cb component, and another inherited index is signalled for Cr component. For another example, it could use chroma intra prediction syntax (e.g., IntraPredModeC [xCb][yCb]) to store the inherited index.

If the current block inherits the cross-component model parameters from neighboring blocks, the current chroma intra prediction mode (e.g., IntraPredModeC [xCb][yCb] as defined in VVC standard) is temporally set to a cross-component mode (e.g., CCLM_LT) at the bitstream syntax parsing stage. Later, at the prediction stage or reconstruction stage, the candidate list is derived, and the inherited candidate model is then determined by the inherit candidate index. After obtaining the inherited model, the coding information of the current block is then updated according to the inherit candidate model. The coding information of the current block includes but not limited to the prediction mode (e.g., CCLM_LT or MMLM_LT), related sub-mode flags (e.g., CCCM mode flag), prediction pattern (e.g., GLM pattern index), and the current model parameters. Then, the prediction of the current block is generated according to the updated coding information.

### Inheriting Multiple Cross-Component Models

The final prediction of the current block could be the combination of multiple cross-component models, or fusion of the selected cross-component models with the prediction by non-cross-component coding tools (e.g., intra angular prediction modes, intra planar/DC modes, or inter prediction modes). In one embodiment, if the current candidate list size is N, it could select k candidates from the total N candidates (where k≤N). Then, k predictions are respectively generated by applying the cross-component model of the selected k candidates using the corresponding luma reconstruction samples. The final prediction of the current block is the combination results of these k predictions. For example, if two candidate predictions (denoted as p_{cand1} and p_{cand2}) are combined, the final prediction at (x, y) position of the current block is p_{final}(x, y)=(1−α)×p_{cand1}(x, y)+α×p_{cand2}(x, y), where α is a weighting factor. Besides, the weighting factor α could be predefined or implicitly derived by neighboring template cost. For example, the corresponding template cost of two candidates can be e^{cand1} and e^{cand2}, then α would be e^{cand1}/(ecand1+e^{cand2}). In another embodiment, if two candidate models are combined, the selected models are from the first two candidates in the list. In still another embodiment, if i candidate models are combined, the selected models are from the first i candidates in the list.

In another embodiment, if the current candidate list size is N, it could select k candidates from the total N candidates (where k≤N). The k cross-component models could be combined into one final cross-component model by weighted-averaging the corresponding model parameters. For example, if a cross-component model has M parameters, the j-th parameter of the final cross-component model are the weighted-averaging of the j-th parameter of the k selected candidates where j is 1 . . . . M. Then, the final prediction is by applying the final cross-component model to the corresponding luma reconstruction samples. For example, if two candidate models are

$$\{ {c}_{0}^{0} , {c}_{1}^{0} , … , {c}_{M - 1}^{0} \} and \{ {c}_{0}^{1} , {c}_{1}^{1} , … , {c}_{M - 1}^{1} \} .$$

The final cross-component model is

$$\{ ( 1 - α ) \times {c}_{0}^{0} + α \times {c}_{0}^{1} , ( 1 - α ) \times {c}_{1}^{0} + α \times {c}_{1}^{1} , … , ( 1 - α ) \times {c}_{M - 1}^{0} + α \times {c}_{M - 1}^{1} \} ,$$

where α is a weighting factor which could be predefined or implicitly derived by neighboring template cost, and

$${c}_{x}^{y}$$

is the x-th model parameter of the y-th candidate. For example, the corresponding template cost of two candidates can be e^{cand1} and e^{cand2}, then α would be e^{cand1}/(e^{cand1}+e^{cand2}). For still another example, the two candidate models are one from spatial adjacent neighboring candidate, and another one from non-adjacent spatial candidate or history candidate. If the spatial adjacent neighboring candidate is not available, then the two candidate models are all from the non-adjacent spatial candidates or history candidates. In another embodiment, if two candidate models are combined, the selected models are from the first two candidates in the list. In still another embodiment, if i candidate models are combined, the selected models are from the first i candidates in the list.

In another embodiment, two cross-component models are combined into one final model by weighted-averaging the corresponding model parameters, where the two cross-component models are one from above spatial neighboring candidate and another one from left spatial neighboring candidate. The above spatial neighboring candidate is the neighboring candidate has the vertical position less than or equal to the top block boundary position of the current block. The left spatial neighboring candidate is the neighboring candidate has the horizontal position less than or equal to the left block boundary position of the current block. The weighting factor α is determined according to the horizontal and vertical spatial positions inside the current block. For example, if two candidate predictions (denoted as p_{above} and p_{left}) are combined, the final prediction at (x, y) position of the current block is p_{final}(x, y)=(1−α)×p_{above}(x, y)+α×p_{left}(x, y), where α=y/(x+y). In another embodiment, the above spatial neighboring candidate is the first candidate in the list has the vertical position less than or equal to the top block boundary position of the current block. The left spatial neighboring candidate is the first candidate in the list has the horizontal position less than or equal to the left block boundary position of the current block.

In another embodiment, it could combine cross-component model candidates with the prediction by (for example, derived by) non-cross-component coding tools. For example, one cross-component model candidate is selected from list, and its prediction is denoted as p_{ccm} (or called as a selected cross-component model). Another prediction could be from chroma DM, chroma DIMD, or intra angular mode, and denoted as p_{non-ccm} (or called as a non-cross-component coding tool). The final prediction at (x, y) position of the current block is p_{final}(x, y)=(1−α)×p_{ccm}(x, y)+α×p_{non-ccm}(x, y), where α is the weighting factor which could be predefined or implicitly derived by neighboring template cost. For still the same example, the prediction by non-cross-component coding tool could be predefined or signalled. The prediction by non-cross-component coding tool is chroma DM or chroma DIMD. For another example, prediction by non-cross-component coding tool is signalled, but the index of cross-component model candidate is predefined or determined by neighboring blocks coding mode. For still the same example, if at least one of neighboring spatial blocks is coded with CCCM mode, the first candidate has CCCM model parameters is selected. If at least one of neighboring spatial blocks is coded with GLM mode, the first candidate has GLM pattern parameters is selected. Similarly, if at least one of neighboring spatial blocks is coded with MMLM mode, the first candidate has MMLM parameters is selected.

In another embodiment, it could combine cross-component model candidates with the prediction by the current cross-component model. For example, one cross-component model candidate is selected from list, and its prediction is denoted as p_{ccm}. Another prediction could be from the cross-component prediction mode by the current neighboring reconstruction samples and denoted as p_{curr-ccm}. The final prediction at (x, y) position of the current block is p_{final}(x, y)=(1−α)×p_{ccm}(x, y)+α×p_{curr-ccm}(x, y), where α is the weighting factor which could be predefined or implicitly derived by neighboring template cost. For still the same example, the prediction by the current cross-component model could be predefined or signalled. The prediction by non-cross-component coding tool is CCCM_LT, LM_LT (single model LM using both top and left neighboring samples to derive model), or MMLM_LT (multi-model LM using both top and left neighboring samples to derive model). In one embodiment, the selected cross-component model candidate is the first candidate in the list.

In another embodiment, it could combine multiple cross-component models into one final cross-component model. For example, it could choose one model from a candidate, and choose second model from another candidate to be a multi-model mode. The selected candidate could be CCLM/MMLM/GLM/CCCM coded candidate. The multi-model classification threshold cloud be the average of the offset parameters (e.g., offset/β in CCLM, or c₆×β or c₆ in CCCM) of the two selected modes. In one embodiment, if two candidate models are combined, the selected models are the first two candidates in the list.

In another embodiment, when combining cross-component model candidates with the prediction by the current cross-component model, the prediction mode of the current cross-component model (e.g., CCLM/MMLM/GLM/CCCM, or their variants) is indicate first, and the syntax for determining if combining with the cross-component model candidates or not is indicated later. For example, the indication of the prediction mode of the current cross-component model can be explicitly signalled or implicitly derived. For another example, the cross-component model candidate is the first candidate in the candidate list. For another example, the cross-component model candidate is the first candidate after reordering the candidate list. For another embodiment, the combination weight can be predefined, determined by the neighboring prediction modes, or implicitly derived by neighboring template cost.

In another embodiment, when combining cross-component model candidates with the prediction by the current cross-component model, the syntax for determining if using the cross-component model candidates is indicate first, and the syntax for determining if combining with the prediction by the current cross-component model and the selected cross-component model candidates or not is indicated later. For example, the current cross-component model is the same as that of the selected candidate. For another example, if the current cross-component model is the same as that of the selected candidate, assume the model of current cross-component model is

$$\{ {c}_{0}^{0} , {c}_{1}^{0} , … , {c}_{M - 1}^{0} \}$$

and the model of the selected candidate is

$$\{ {c}_{0}^{1} , {c}_{1}^{1} , … , {c}_{M - 1}^{1} \} .$$

The final cross-component model is

$$\{ ( 1 - α ) \times {c}_{0}^{0} + α \times {c}_{0}^{1} , ( 1 - α ) \times {c}_{1}^{0} + α \times {c}_{1}^{1} , … , ( 1 - α ) \times {c}_{M - 1}^{0} + α \times {c}_{M - 1}^{1} \} ,$$

where α is a weighting factor which could be predefined, determined by the neighboring prediction modes, or implicitly derived by neighboring template cost, and

$${c}_{x}^{y}$$

are the model parameters.

In another embodiment, whether to apply the approach of combining cross-component model candidates with the prediction by the current cross-component model can depend on block size constraint. The block size constraint can be the block size is less than or equal to a threshold, or the block size is greater than or equal to a threshold. The block size can be referred to the block width, block height, block width multiply block height, block width plus block height, block size aspect ratio, or their variants.

Signalling for Combining with Inherited Cross-Component Models

When combining multiple chroma predictions as the final prediction is allowed, a chroma fusion syntax is firstly signalled. The chroma fusion syntax is used to indicate if the final prediction of the current block can be the combination of multiple cross-component models, or fusion of the selected cross-component models with the prediction by non-cross-component coding tools (e.g., intra angular prediction modes, intra planar/DC modes, or inter prediction modes) or not.

If the chroma fusion syntax is true, a fusion-with-inherit-model syntax is signalled to indicate if the current chroma prediction is combined with the prediction using the inherited cross-component model as the final prediction or not. If chroma fusion syntax is true and the fusion-with-inherit-model syntax is false, another syntax is used to indicate the prediction combination method of the final chroma prediction explicitly or implicitly.

If the current chroma prediction mode is LM related modes and the final chroma prediction does not combine with multiple chroma predictions, a syntax is used to indicate if the final prediction is derived using the inherited cross-component model or not. If the current chroma prediction mode is LM related modes (or cross-component prediction modes) and the prediction is not derived using the inherited cross-component model, the LM related mode and LM related coding information is indicated explicitly or implicitly.

If the current chroma prediction mode is not LM related modes, the current chroma prediction mode (e.g., intra angular prediction modes, intra planar/DC modes) is indicated explicitly or implicitly.

If the final prediction is derived using the inherited cross-component model or the fusion-with-inherit-model syntax is true, the index of the selected cross-component models is indicated explicitly or implicitly.

In one embodiment, the chroma prediction method can be signalled using the following syntax:

```
is_chroma_fusion
if (is_chroma_fusion) {
  is_fusion_with_ccmerge
  if (!is_fusion_with_ccmerge) {
    fusion_mode_idc
  }
}
is_LM
if (is_LM) {
  if (!is_chroma_fusion) {
    is_ccmerge
  }
  if (!is_ccmerge) {
    LM_mode_idc
    /* also can signal LM related coding information here */
  }
} else {
  DC/regular intra mode index
}
if (is_ccmerge || is_fusion_with_ccmerge) {
  ccmerge_idc
}
```

is_chroma_fusion indicate if the final prediction of the current block can be the combination of multiple cross-component models, or fusion of the selected cross-component models with the prediction by non-cross-component coding tools.

Is_fusion_with_ccmerge indicates if the current chroma prediction is combined with the prediction using the inherited cross-component model as the final prediction.

Fusion_mode_idc indicate the prediction combination method of the final chroma prediction explicitly or implicitly.

Is_LM indicates if the current chroma prediction mode is LM related mode (or cross-component prediction modes) or not.

Is_ccmerge indicates if the final prediction is derived using the inherited cross-component model or not.

LM_mode_idc indicates the cross-component coding mode.

DC/regular intra mode index indicates the non-cross-component coding mode.

Ccmerge_ide indicates the index of the selected cross-component models.

In another embodiment, if the final prediction of the current block is only allowed to be combined with the prediction using the inherited cross-component model, the chroma prediction method can be signalled using the following syntax:

```
is_chroma_fusion
is_LM
if (is_LM) {
  if (!is_chroma_fusion) {
    is_ccmerge
  }
  if (!is_ccmerge) {
    LM_mode_idc
    /* also can signal LM related coding information here */
  }
} else {
  DC/regular intra mode index
}
if (is_ccmerge || is_chroma_fusion) {
  ccmerge_idc
}
```

In another embodiment, if the final prediction of the current block is allowed to be combined with the prediction using the first inherited cross-component model (e.g., after reordering the candidates in the list), the chroma prediction method can be signalled using the following syntax. When is_fusion_with_ccmerge is 1, ccmerge_idc is inferred to 1. The method can be signalled using the following syntax:

```
is_chroma_fusion
if (is_chroma_fusion) {
  is_fusion_with_ccmerge
  if (!is_fusion_with_ccmerge) {
    fusion_mode_idc
  }
}
is_LM
if (is_LM) {
  if (!is_chroma_fusion) {
    is_ccmerge
    if (is_ccmerge) {
      ccmerge_idc
    }
  }
  if (!is_ccmerge) {
    LM_mode_idc
    /* also can signal LM related coding information here */
  }
} else {
  DC/regular intra mode index
}
```

In another embodiment, if LM mode is not allowed for the current slice or picture, is_chroma_fusion/is_LM/is_ccmerge/is_fusion_with_ccmerge are inferred to 0.

Any of the foregoing disclosed methods can be implemented in encoders and/or decoders. For example, any of the disclosed methods can be implemented in an inter/intra/prediction module of an encoder, and/or an inter/intra/prediction module of a decoder. Alternatively, any of the proposed methods can be implemented as a circuit coupled to the inter/intra/prediction module of the encoder and/or the inter/intra/prediction module of the decoder, so as to provide the information needed by the inter/intra/prediction module.

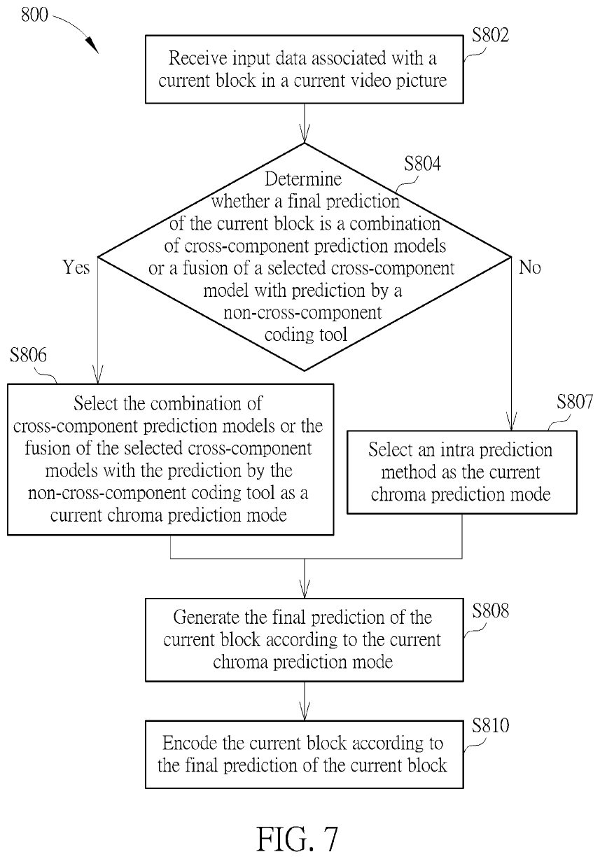

FIG. 7 is a flowchart illustrating an embodiment of a video processing method 800 for encoding a current block. The method 800 comprises the following steps:
S802: Receive input data associated with a current block in a current video picture;
S804: Determine whether a final prediction of the current block is a combination of cross-component prediction models or a fusion of a selected cross-component model with prediction by a non-cross-component coding tool; if so, proceed to S806; if not, proceed to S807;
S806: Select the combination of cross-component prediction models or the fusion of the selected cross-component models with the prediction by the non-cross-component coding tool as a current chroma prediction mode; proceed to step S808;
S807: Select an intra prediction method as the current chroma prediction mode;
S808: Generate the final prediction of the current block according to the current chroma prediction mode; and
S810: Encode the current block according to the final prediction of the current block.

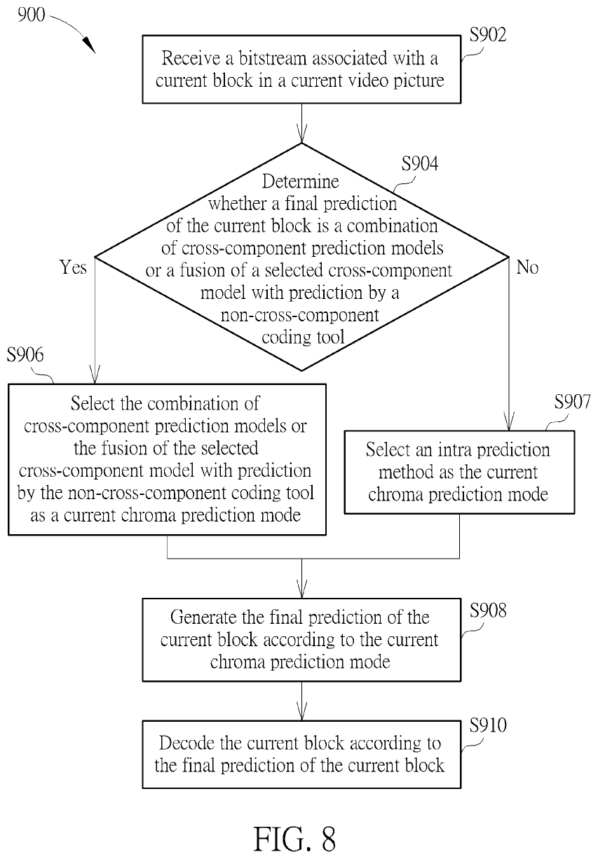

FIG. 8 is a flowchart illustrating an embodiment of a video processing method 900 for decoding a current block. The method 900 comprises the following steps:
S902: Receive a bitstream associated with a current block in a current video picture;
S904: Determine whether a final prediction of the current block is a combination of cross-component prediction models or a fusion of a selected cross-component model with prediction by a non-cross-component coding tool; if so, proceed to S906; if not, proceed to S907;
S906: Select the combination of cross-component prediction models or the fusion of the selected cross-component model with prediction by the non-cross-component coding tool as a current chroma prediction mode; proceed to step S908;
S907: Select an intra prediction method as the current chroma prediction mode;
S908: Generate the final prediction of the current block according to the current chroma prediction mode; and
S910: decode the current block according to the final prediction of the current block.

### Video Encoder and Decoder

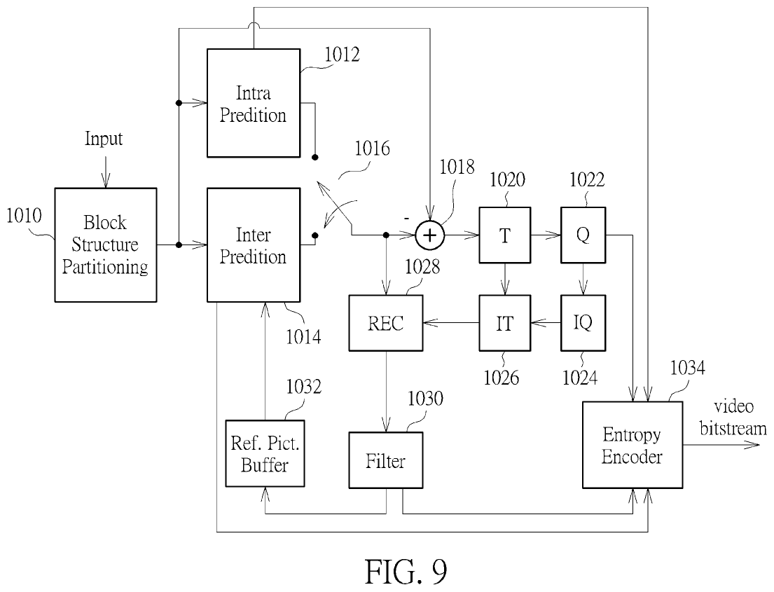

FIG. 9 depicts a video encoder 1000 which implements various above described methods for video processing in accordance with the embodiments. The main component responsible for this is the Block Structure Partitioning Module 1010, which divides the input video into non-overlapping blocks and further partitions each block using a recursive structure into leaf blocks. The module checks if predefined splitting types are allowed based on constraints related to pipeline units, which are non-overlapping units in the current video picture designed for pipeline processing. The allowed splitting type that optimizes rate-distortion is selected, and the corresponding information is signalled in the video bitstream for the decoders to decode the current block.

Each leaf block in the current video picture is then processed by either the Intra Prediction Module 1012 or the Inter Prediction Module 1014, depending on whether spatial or temporal redundancy is being removed. The Intra Prediction Module 1012 generates intra predictors for the current leaf block using reconstructed data from the same picture, while the Inter Prediction Module 1014 performs motion estimation and compensation to provide inter predictors based on other pictures. The residual signal (prediction errors) of the current leaf block is then processed by the Transform (T) Module 1020 and Quantization (Q) Module 1022, before being encoded into the compressed video bitstream by the Entropy Encoder 1034.

To reconstruct the video, the quantized transform coefficients are processed by the Inverse Quantization (IQ) Module 1024 and the Inverse Transform (IT) Module 1026 to recover the residual signal. The Reconstruction (REC) Module 1028 then produces the reconstructed video by adding the residual to the prediction. Finally, the In-loop Processing Filter 1030 enhances the reconstructed picture quality before storing it in the Reference Picture Buffer 1032 for later inter prediction.

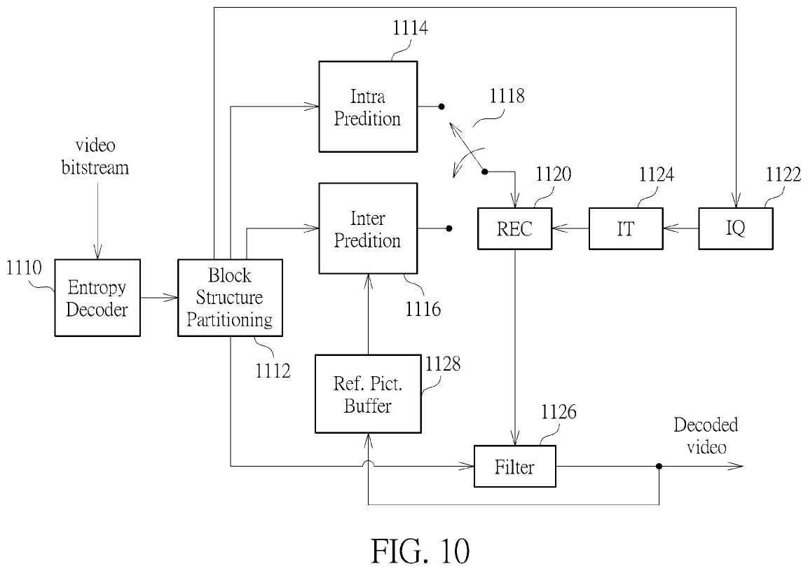

FIG. 10 depicts a video decoder 1100 which implements various above described methods for video processing in accordance with the embodiments. The video decoder 1100 is designed to decode the video bitstream generated by the video encoder 1000. The input to the decoder is first processed by the Entropy Decoder 1110, which parses and recovers the transformed and quantized residual signal and other system information. The Block Structure Partitioning Module 1112 then determines the block partitioning structure for each block in the video picture, following similar constraints as the encoder.

The decoding process is similar to the reconstruction loop at the encoder, with the main difference being that the decoder only requires motion compensation prediction in the Inter Prediction Module 1116. Each leaf block is decoded using either the Intra Prediction Module 1114 or the Inter Prediction Module 1116, and the appropriate predictor is selected by Switch 1118 based on the decoded mode information. The transformed and quantized residual signal is recovered by the Inverse Quantization (IQ) Module 1122 and Inverse Transform (IT) Module 1124, and then added back to the predictor in the Reconstruction (REC) Module 1120 to produce the reconstructed video. The reconstructed video is further processed by the In-loop Processing Filter 1126 to generate the final decoded video, which is stored in the Reference Picture Buffer 1128 if it is a reference picture.

The various components of the video encoder 1000 and video decoder 1100 can be implemented using hardware components, processors executing program instructions stored in memory, or a combination of both. The processor may have single or multiple processing cores and is coupled with memory to store program instructions, reconstructed data, and intermediate data during the encoding or decoding process. The memory can be a non-transitory computer readable medium, such as solid-state memory device, RAM, ROM, hard disk, optical disk, or a combination thereof. When the encoder and decoder are implemented in the same electronic device, functional components may be shared or reused. The embodiments of the invention can be implemented in the Intra Prediction Modules 1012 and 1114 of the encoder 1000 and decoder 1100, respectively, or as one or more separate circuits coupled to these modules.

The various embodiments of the method revealed in this disclosure enhance coding efficiency by a unified signalling method for combining multiple chroma prediction modes, particularly when inheriting cross-component models. By efficiently signalling the combination of various chroma intra prediction techniques, the invention seeks to exploit spatial and inter-component correlations more effectively, ultimately leading to better compression and decompression performance while maintaining visual quality.

### ADDITIONAL NOTE

It is important to note that in the context of this disclosure, the terms “cross-component prediction model” and “linear model” are considered equivalent and can be used interchangeably. Both terms refer to methods that exploit the correlation between luma and chroma components to predict chroma samples based on corresponding luma samples. These models typically employ a linear transformation of the luma values to estimate the chroma values while the cross-component aspect emphasizes that the prediction occurs across different color components of the video signal.

Thus, to accommodate the evolving nature of video coding techniques and ensure compatibility with current and future industry standards (e.g., H.265/HEVC), flexible terminology is used when referring to prediction models.

Throughout this disclosure, when either “cross-component prediction model” or “linear model” is mentioned, it should be understood that they refer to the same class of prediction techniques used in chroma coding. This equivalence encompasses various specific implementations such as Cross-Component Linear Model (CCLM), Multi-model LM (MMLM), Gradient Linear Model (GLM), and Convolutional Cross-Component Model (CCCM), all of which fall under the broader category of cross-component prediction models or linear models in video compression. This interchangeability of technical terminology does not alter the core functionalities or characteristics of the techniques described in this disclosure. The underlying principles, methods, and applications remain consistent regardless of the specific terminology used.

The terminology employed in the description of the various embodiments herein is intended for the purpose of describing particular embodiments and should not be construed as limiting. In the context of this description and the appended claims, the singular forms “a”, “an”, and “the” are intended to encompass plural forms as well, unless the context clearly indicates otherwise.

It should be understood that the term “and/or” as used herein is intended to encompass any and all possible combinations of one or more of the associated listed items. Furthermore, it should be noted that the terms “includes,” “including,” “comprises,” and/or “comprising,” when used in this specification, indicate the presence of stated features, integers, steps, operations, elements, and/or components, but do not exclude the presence or addition of one or more other features, integers, steps, operations, elements, components, and/or groups thereof.

The use of ordinal designators like “first,” “second,” and so forth in the specification and claims serves to differentiate between multiple instances of similarly named elements. These designators do not imply any inherent sequence, priority, or chronological order in the manufacturing process or functional relationship between elements. Rather, they are employed solely as a means of uniquely identifying and distinguishing between separate instances of elements that share a common name or description.

Unless specifically stated otherwise, the term “some” refers to one or more. Various combinations using “at least one of” or “one or more of” followed by a list (e.g., A, B, or C) should be interpreted to include any combination of the listed items, including individual items and multiple items.

Terms such as “coupled,” “connected,” “connecting,” and “electrically connected” are used synonymously to describe a state of being electrically or electronically linked. When an entity is described as being in “communication” with another entity or entities, it implies the capability of sending and/or receiving electrical signals, which may contain voice or non-voice data/control information, regardless of whether these signals are analog or digital in nature.

This interpretation of terminology is provided to ensure clarity and consistency throughout the specification and claims, and should not be construed as restricting the scope of the disclosed embodiments or the appended claims.

The various illustrative components, logic, logical blocks, modules, circuits, operations and algorithm processes described in connection with the embodiments disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus utilized to implement the various illustrative components, logics, logical blocks, modules, and circuits described herein may comprise, without limitation, one or more of the following: a general-purpose single-chip or multi-chip processor, a digital signal processor (DSP), an application specific integrated circuit (ASIC), a field programmable gate array (FPGA), other programmable logic devices (PLDs), discrete gate or transistor logic, discrete hardware components, or any suitable combination thereof. Such hardware and apparatus shall be configured to perform the functions described herein.

A general-purpose processor may include, but is not limited to, a microprocessor, or alternatively, any conventional processor, controller, microcontroller, or state machine. In certain implementations, a processor may be realized as a combination of computing devices. Such combinations may include, for example, a DSP and a microprocessor, a plurality of microprocessors, one or more microprocessors in conjunction with a DSP core, or any other such configuration as may be suitable for the intended application.

It is to be understood that in some embodiments, particular processes, operations, or methods may be executed by circuitry specifically designed for a given function. Such function-specific circuitry may be optimized to enhance performance, efficiency, or other relevant metrics for the particular task at hand. The selection of specific hardware implementation shall be determined based on the particular requirements of the application, which may include, inter alia, performance specifications, power consumption constraints, cost considerations, and size limitations.

In certain aspects, the subject matter described herein may be implemented as software. Specifically, various functions of the disclosed components, or steps of the methods, operations, processes, or algorithms described herein, may be realized as one or more modules within one or more computer programs. These computer programs may comprise non-transitory processor-executable or computer-executable instructions, encoded on one or more tangible processor-readable or computer-readable storage media. Such instructions are configured for execution by, or to control the operation of, data processing apparatus, including the components of the devices described herein. The aforementioned storage media may include, but are not limited to, RAM, ROM, EEPROM, CD-ROM or other optical disk storage, magnetic disk storage or other magnetic storage devices, or any other medium capable of storing program code in the form of instructions or data structures. It should be understood that combinations of the above-mentioned storage media are also contemplated within the scope of computer-readable storage media for the purposes of this disclosure.

Various modifications to the embodiments described in this disclosure may be readily apparent to persons having ordinary skill in the art, and the generic principles defined herein may be applied to other embodiments without departing from the spirit or scope of this disclosure. Thus, the claims are not intended to be limited to the embodiments shown herein, but are to be accorded the widest scope consistent with this disclosure, the principles and the novel features disclosed herein.

In certain implementations, the embodiments may comprise the disclosed features and may optionally include additional features not explicitly described herein. Conversely, alternative implementations may be characterized by the substantial or complete absence of non-disclosed elements. For the avoidance of doubt, it should be understood that in some embodiments, non-disclosed elements may be intentionally omitted, either partially or entirely, without departing from the scope of the invention. Such omissions of non-disclosed elements shall not be construed as limiting the breadth of the claimed subject matter, provided that the explicitly disclosed features are present in the embodiment.

Additionally, various features that are described in this specification in the context of separate embodiments also can be implemented in combination in a single implementation. Conversely, various features that are described in the context of a single implementation also can be implemented in multiple embodiments separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

The depiction of operations in a particular sequence in the drawings should not be construed as a requirement for strict adherence to that order in practice, nor should it imply that all illustrated operations must be performed to achieve the desired results. The schematic flow diagrams may represent example processes, but it should be understood that additional, unillustrated operations may be incorporated at various points within the depicted sequence. Such additional operations may occur before, after, simultaneously with, or between any of the illustrated operations.

Additionally, it should be understood that the various figures and component diagrams presented and discussed within this document are provided for illustrative purposes only and are not drawn to scale. These visual representations are intended to facilitate understanding of the described embodiments and should not be construed as precise technical drawings or limiting the scope of the invention to the specific arrangements depicted.

In certain implementations, multitasking and parallel processing may prove advantageous. Furthermore, while various system components are described as separate entities in some embodiments, this separation should not be interpreted as mandatory for all embodiments. It is contemplated that the described program components and systems may be integrated into a single software package or distributed across multiple software packages, as dictated by the specific implementation requirements.

It should be noted that other embodiments, beyond those explicitly described, fall within the scope of the appended claims. The actions specified in the claims may, in some instances, be performed in an order different from that in which they are presented, while still achieving the desired outcomes. This flexibility in execution order is an inherent aspect of the claimed processes and should be considered within the scope of the invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of video processing in a video coding system for encoding pictures, comprising:
receiving input data associated with a current block in a current video picture;
determining whether a final prediction of the current block is a combination of a plurality of cross-component prediction models or a fusion of a selected cross-component model with prediction by a non-cross-component coding tool;
selecting the combination of the plurality of cross-component prediction models or the fusion of the selected cross-component model with the prediction by the non-cross-component coding tool as a current chroma prediction mode if the final prediction of the current block is the combination of the plurality of cross-component prediction models or the fusion of the selected cross-component model with the prediction by the non-cross-component coding tool;
generating the final prediction of the current block according to the current chroma prediction mode; and
encoding the current block according to the final prediction of the current block.

2. The method of claim 1, further comprising:
determining whether the current chroma prediction mode is combined with an inherited cross-component model; and
using additional signalling to indicate a prediction combination method of the final prediction if the current chroma prediction mode is not combined with an inherited cross-component model.

3. The method of claim 1, further comprising:
signaling a syntax to indicate that the final prediction of the current block is the combination of the plurality of cross-component prediction models or the fusion of the selected cross-component model with the prediction by the non-cross-component coding tool.

4. The method of claim 3, wherein determining whether the current chroma prediction mode is a cross-component prediction mode is performed before signaling the syntax to indicate the final prediction of the current block is the combination of the plurality of cross-component prediction models or the fusion of the selected cross-component model with the prediction by the non-cross-component coding tool.

5. The method of claim 1, wherein an index of the selected cross-component model is indicated explicitly or derived implicitly.

6. The method of claim 1, wherein determining whether the final prediction of the current block is the combination of the plurality of cross-component prediction models or the fusion of the selected cross-component model with prediction by the non-cross-component coding tool is performed before determining whether the current chroma prediction mode is a cross-component prediction mode or not.

7. The method of claim 1, wherein the plurality of cross-component prediction models comprise at least two of a Cross-Component Linear Model (CCLM), a Multi-model LM (MMLM), a Gradient Linear Model (GLM) and a Convolutional Cross-Component Model (CCCM).

8. The method of claim 1, wherein the non-cross-component coding tool comprises an angular mode, a planar mode or a DC mode.

9. A method of video processing in a video coding system for decoding pictures, comprising:
receiving a bitstream associated with a current block in a current video picture;
determining whether a final prediction of the current block is a combination of a plurality of cross-component prediction models or a fusion of a selected cross-component model with prediction by a non-cross-component coding tool;
selecting the combination of the plurality of cross-component prediction models or the fusion of the selected cross-component model with prediction by the non-cross-component coding tool as a current chroma prediction mode if the final prediction of the current block is the combination of the plurality of cross-component prediction models or the fusion of the selected cross-component model with the prediction by the non-cross-component coding tool;
generating the final prediction of the current block according to the current chroma prediction mode; and
decoding the current block according to the final prediction of the current block.

10. The method of claim 9, further comprising:
determining whether the current chroma prediction mode is combined with an inherited cross-component model; and
using additional signalling to indicate a prediction combination method of the final prediction if the current chroma prediction mode is not combined with an inherited cross-component model.

11. The method of claim 9, further comprising:
parsing a syntax to indicate that the final prediction of the current block is the combination of the plurality of cross-component prediction models or the fusion of the selected cross-component model with the prediction by the non-cross-component coding tool.

12. The method of claim 11, wherein determining whether the current chroma prediction mode is a cross-component prediction mode is performed before parsing the syntax to indicate the final prediction of the current block is the combination of the plurality of cross-component prediction models or the fusion of the selected cross-component model with the prediction by the non-cross-component coding tool.

13. The method of claim 9, wherein an index of the selected cross-component models is indicated explicitly or derived implicitly.

14. The method of claim 9, wherein determining whether the final prediction of the current block is a combination of a plurality of cross-component prediction models or a fusion of the selected cross-component model with the prediction by the non-cross-component coding tool is performed before determining whether the current chroma prediction mode is a cross-component prediction mode or not.

15. The method of claim 9, wherein the plurality of cross-component prediction models comprise at least two of a Cross-Component Linear Model (CCLM), a Multi-model LM (MMLM), a Gradient Linear Model (GLM) and a Convolutional Cross-Component Model (CCCM).

16. The method of claim 9, wherein the non-cross-component coding tool comprises an angular mode, a planar mode or a DC mode.

17. An apparatus comprising a decoder circuit, the decoder circuit configured to:
receive a bitstream associated with a current block in a current video picture;
determine whether a final prediction of the current block is a combination of a plurality of cross-component prediction models or a fusion of a selected cross-component model with prediction by a non-cross-component coding tool;
select the combination of the plurality of cross-component prediction models or the fusion of the selected cross-component model with prediction by a non-cross-component coding tool as a current chroma prediction mode if the final prediction of the current block is the combination of the plurality of cross-component prediction models or the fusion of the selected cross-component model with prediction by a non-cross-component coding tool;
generate the final prediction of the current block according to the current chroma prediction mode; and
decode the current block according to the final prediction of the current block.
